(19) United States
(12) Patent Application Publication
(10) Pub. No.: US 2018/0275579 A1
(43) Pub. Date: Sep. 27, 2018

(54) IMAGE FORMING APPARATUS

(71) Applicant: FUJI XEROX CO., LTD., Tokyo (JP)

(72) Inventor: Yuki YOKOYAMA, Kanagawa (JP)

(73) Assignee: FUJI XEROX CO., LTD., Tokyo (JP)

(21) Appl. No.: 15/797,776

(22) Filed: Oct. 30, 2017

(30) Foreign Application Priority Data
Mar. 22, 2017 (JP) 2017-056197

(51) Int. Cl. G03G 15/10

(52) U.S. Cl. CPC G03G 15/5062; G03G 15/104

(57) ABSTRACT

An image forming apparatus includes a developing member, a developer supply unit, a pulsating pump, and a correction unit. The developing member is to be supplied with a liquid developer from a supply member and is configured to develop an electrostatic latent image formed on an image carrier. The developer supply unit forms a closed space together with the supply member. The closed space stores the liquid developer. The pulsating pump is configured to feed the liquid developer to the closed space at a predetermined reference flow rate. The correction unit is configured to make a correction to achieve increase or decrease with respect to the reference flow rate according to presence or absence of image information used for forming the electrostatic latent image, in units of a predetermined processing length in a process direction intersecting a development width on the image carrier.

### CROSS-REFERENCE TO RELATED APPLICATIONS

This application is based on and claims priority under 35 USC 119 from Japanese Patent Application No. 2017-056197 filed Mar. 22, 2017.

### BACKGROUND

### Technical Field

Exemplary embodiments of the present invention relate to an image forming apparatus.

### SUMMARY

According to an aspect of the invention, an image forming apparatus includes a developing member, a developer supply unit, a pulsating pump, and a correction unit. The developing member is to be supplied with a liquid developer from a supply member and is configured to develop an electrostatic latent image formed on an image carrier. The developer supply unit forms a closed space together with the supply member. The closed space stores the liquid developer. The pulsating pump is configured to feed the liquid developer to the closed space at a predetermined reference flow rate. The correction unit is configured to make a correction to achieve increase or decrease with respect to the reference flow rate according to presence or absence of image information used for forming the electrostatic latent image, in units of a predetermined processing length in a process direction intersecting a development width on the image carrier.

### BRIEF DESCRIPTION OF THE DRAWINGS

Exemplary embodiments of the present invention will be described in detail based on the following figures, wherein:

FIG. 1 is a schematic view of an image forming apparatus according to an exemplary embodiment;

FIG. 2 is a schematic view of an image forming unit according to the exemplary embodiment;

FIG. 3A is a characteristic diagram obtained by measuring an image density change amount with respect to a processing time when an image is formed based on image data having a certain image density (for example, a black solid image, a halftone gray image, or the like);

FIG. 3B is a characteristic diagram obtained by measuring a pressure change amount within a doctor chamber when a supply pump employed in the exemplary embodiment is driven to supply a liquid developer G to the doctor chamber;

FIG. 4 is a plan view of a recording medium P on which images are formed; and

FIG. 5 is a flow chart according to the exemplary embodiment, illustrating the flow of a supply control of the liquid developer G by the supply pump in a main controller.

### DETAILED DESCRIPTION

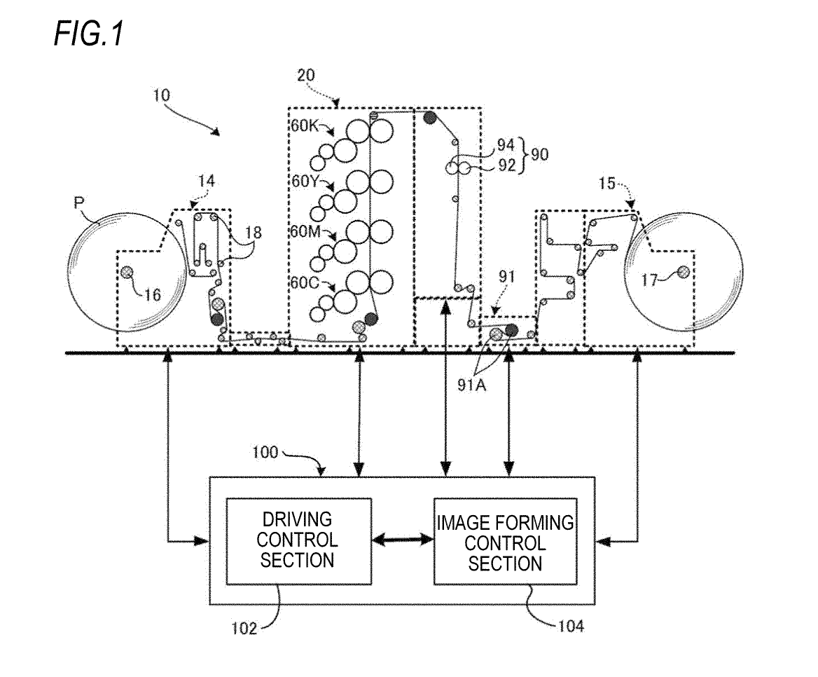

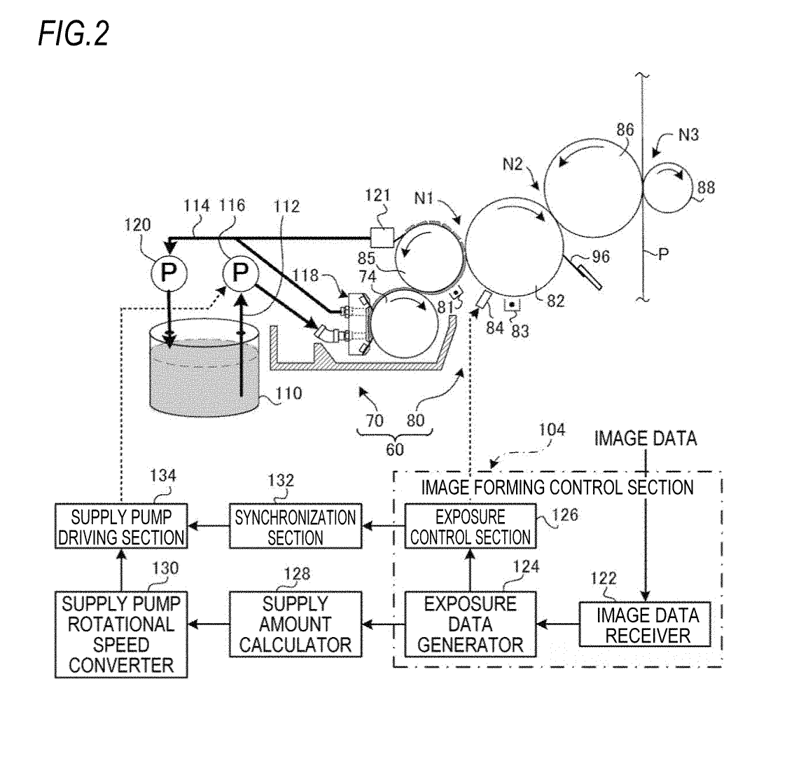

FIG. 1 schematically illustrates an image forming apparatus 10 according to an exemplary embodiment. The image forming apparatus 10 of the exemplary embodiment employs a liquid developer G (see FIG. 2) as a developer.

A recording medium P is wound in a layered form and loaded on a sheet feeding roller 16 of a sheet feeding section 14 in advance.

The recording medium P wound on the sheet feeding roller 16 is drawn out from the outermost layer of the sheet feeding roller 16, wrapped around plural wrapping rollers 18, and delivered to an image forming section 20. The recording medium P on which an image is formed in the image forming section 20 is wound around a winding roller 17 of an accommodating section 15. The winding roller 17 rotates so as to wind the recording medium P in a layered form.

A part of the wrapping rollers 18 serves as driving rollers, and wind the recording medium P around the winding roller 17 while adjusting the tension of the recording medium P between the respective rollers.

The image forming apparatus 10 includes a main controller 100. The main controller 100 includes a driving control section 102 of a drive system and an image forming control section 104. The driving control section 102 controls the driving of the driving system (mainly a motor) that transports the recording medium P through the sheet feeding section 14, the image forming section 20, and the accommodating section 15. The image forming control section 104 acquires image data from the outside, converts the image data into exposure data, and controls image formation processing in the image forming section 20.

The image forming apparatus 10 of the exemplary embodiment is configured to transfer and fix an image (a toner image) formed of toner particles contained in the liquid developer G (see FIG. 2) on the surface of the recording medium P so that the image is formed on the surface of the recording medium P.

The image forming section 20 has a function of forming a toner image using the liquid developer G, transferring the toner image to the surface of the recording medium P, fixing a toner on the surface of the recording medium P, and forming an image on the surface of the recording medium P. In the image forming section 20, image forming units 60C, 60M, 60Y, and 60K are disposed in a vertical direction of FIG. 1 (in an apparatus height direction), and driving rollers are provided upstream and downstream of the image forming units 60C, 60M, 60Y, and 60K.

Here, the suffix “C” indicates cyan, “M” indicates magenta, “Y” indicates yellow, and “K” indicates black. The image forming units 60C, 60M, 60Y, and 60K are configured to form toner images of C, M, Y, and K colors, respectively. The arrangement of the image forming units 60C, 60M, 60Y, and 60K is not limited to the vertical arrangement as illustrated in FIG. 1. The image forming units 60C, 60M, 60Y, and 60K may be horizontally arranged.

The driving rollers are the part of the rollers provided along the transport path of the recording medium P in the image forming apparatus 10 and are driven by receiving a driving force. The rotational speeds of the driving rollers are independently controlled by the driving control section 102 of the main controller 100. For example, the transport speed by the driving rollers at the downstream side is made faster than the transport speed by the driving rollers at the upstream side so as to maintain the tension during the transport of the recording medium P within a predetermined range.

The image forming units 60C, 60M, 60Y, and 60K have a function of forming toner images of the respective colors and transferring the toner images of the respective colors to the recording medium P that is being transported. The image forming units 60C, 60M, 60Y, and 60K are arranged in this order along the transport path of the recording medium P from the upstream side to the downstream side (from the lower side to the upper side in FIG. 1) in a transport direction of the recording medium P.

As illustrated in FIG. 1, a fixing device 90 and a drying section 91 are provided downstream of the image forming units 60C, 60M, 60Y, and 60K. The fixing device 90 includes a heating roller 92 and a pressure roller 94.

The fixing device 90 has a function of heating and pressing multi-color toner images formed on the surface of the recording medium P by the image forming units 60, thereby fixing the toner images formed by the respective image forming units 60C, 60M, 60Y, and 60K to the surface of the recording medium P.

The drying section 91 has a function of winding the recording medium P around drying rollers 91A, thereby heating and drying the recording medium P.

Hereinafter, description will be given on details of the image forming units 60C, 60M, 60Y, and 60K with reference to FIG. 2. It should be noted that the suffixes C, M, Y, and K will be omitted in the following descriptions. That is, the image forming units 60C, 60M, 60Y, and 60K have the same configuration, except for the toner color of the toner contained in the liquid developer G used for each of the image forming units 60C, 60M, 60Y, and 60K.

As illustrated in FIG. 2, the image forming unit 60 includes a developer supply section 70 and a transfer section 80.

The developer supply section 70 has a function of storing the liquid developer G and supplying the liquid developer G to the transfer section 80.

The developer supply section 70 includes a tank 110. The tank 110 stores the liquid developer G. A supply pipe 112 and a recovery pipe 114 are attached to the tank 110.

The supply pipe 112 is connected to an inlet side opening of a closed liquid developer supply device 118 (hereinafter, referred to as a “doctor chamber 118”) as an example of a developer supply unit, via a supply pump 116. With this configuration, the liquid developer G within the tank 110 is supplied to the doctor chamber 118 by driving the supply pump 116.

The supply pump 116 is a pump that employs, as a supply system, a positive displacement reciprocating supply system (hereinafter, referred to as a “pulsating system”). The supply pump 116 supplies the liquid developer G to the doctor chamber 118 at a flow rate having a constant frequency. That is, the supply flow rate of the liquid developer G varies with time.

The doctor chamber 118 includes a main body and a pair of blades. The main body includes a chamber portion configured to supply the liquid developer G to a supply roller 74. The pair of blades is configured to keep the chamber portion in a closed space and adjust the surface radius dimension of the liquid developer G supplied to the supply roller 74 to be constant.

That is, the doctor chamber 118 has a function of supplying the liquid developer G within the tank 110 without basically exposing the liquid developer G to air, in a state where the surface radius dimension of the liquid developer G is constant on the circumferential surface of the supply roller 74.

Plural grooves are formed along the axial direction on the circumferential surface of the supply roller 74. Since the grooves are formed on the circumferential surface of the supply roller 74, a film thickness of the liquid developer G varies between a groove portion and a non-groove portion so that the liquid developer G has an uneven shape. The grooves serve to increase a holding force of the supplied liquid developer G on the circumferential surface of the supply roller 74 as compared to a holding force when the liquid developer G is held with a constant film thickness on a flat circumferential surface.

Meanwhile, the recovery pipe 114 is connected to an outlet side opening of the doctor chamber 118 via a recovery pump 120. With this configuration, the surplus liquid developer G within the doctor chamber 118 is recovered to the tank 110 by driving the recovery pump 120. The recovery pipe 114 branches off upstream of the recovery pump 120 and is connected to a recovery device 121 that collects the surplus liquid developer G on the circumferential surface of a developing roller 85 to be described below. A pulsating pump is employed in the recovery pump 120.

The liquid developer G holds toner particles containing polyester as a main component, with a carrier liquid. For example, a volatile liquid such as a paraffin oil may be employed as the carrier liquid.

A voltage is applied to the supply roller 74. The supply roller 74 receives the liquid developer G from the doctor chamber 118 while rotating. The supply roller 74 supplies the liquid developer G to the developing roller 85, as an example of a developing member, located downstream of the supply roller 74. Here, the layer thickness of the liquid developer G is adjusted by a blade (not illustrated) provided on the supply roller 74. The liquid developer G is supplied to the developing roller 85 to which the voltage is applied. A charging device 81 faces the circumferential surface of the developing roller 85. The charging device 81 serves to impart electric charges (e.g., positive charges) to the liquid developer G.

The transfer section 80 includes a photoconductor drum 82, a photoconductor charging device 83, an exposure device 84, the developing roller 85, an intermediate transfer roller 86, and a backup roller 88.

The transfer section 80 transfers a toner image formed on the photoconductor drum 82, as an image carrier, located downstream of the developing roller 85 to the recording medium P using the liquid developer G.

The photoconductor drum 82 has a function of carrying a latent image. The photoconductor charging device 83 has a function of uniformly charging the surface of the photoconductor drum 82.

The exposure device 84 has a function of forming the latent image on the surface of the photoconductor drum 82 charged by the photoconductor charging device 83, based on image data received by the image forming control section 104 (see FIG. 1). The latent image is a region charged to a potential different from a potential of the uniformly charged surface due to the irradiation with a light beam from the exposure device 84.

The developing roller 85 has a function of developing the latent image carried by the photoconductor drum 82 into a toner image using the liquid developer G supplied from the developer supply section 70.

The developing roller 85 forms a nip N1 together with the photoconductor drum 82. Then, a voltage is applied to the developing roller 85 while the developing roller 85 rotates. The developing roller 85 is configured to develop the latent image carried by the photoconductor drum 82 into the toner image using an electric field formed at the nip N1.

The intermediate transfer roller 86 is located downstream of the photoconductor drum 82. The intermediate transfer roller 86 has a function of primarily transferring the toner image formed on the photoconductor drum 82 to the outer circumferential surface of the intermediate transfer roller 86 and carrying the transferred toner image.

The intermediate transfer roller 86 forms a nip N2 together with the photoconductor drum 82. Then, a voltage of, for example, -600V is applied to the intermediate transfer roller 86 while the intermediate transfer roller 86 rotates. The intermediate transfer roller 86 is configured to primarily transfer the toner image on the photoconductor drum 82 to the outer circumferential surface of the intermediate transfer roller 86 using an electric field formed at the nip N2.

A cleaning blade 96 is disposed on the photoconductor drum 82 to scrape off toner particles that have not been transferred in the primary transfer at the nip N2.

The backup roller 88 has a function of secondarily transferring the toner image carried on the outer circumferential surface of the intermediate transfer roller 86 to the recording medium P that is being transported. The backup roller 88 is disposed to be opposite to the intermediate transfer roller 86 across the transport path of the recording medium P. The backup roller 88 forms a nip N3 together with the intermediate transfer roller 86.

At the nip N3, the toner image carried on the outer circumferential surface of the intermediate transfer roller 86 is secondarily transferred to the recording medium P using the electric field formed between the photoconductor drum 82 and the recording medium P.

Here, in a comparative example, the pulsating pump is employed in the supply pump 116, and the liquid developer G is delivered in a closed state by the doctor chamber 118 from the tank 110 to the supply roller 74 without basically being exposed to air. This configuration may cause the following phenomenon. That is, a pulsation (vibration) of the supply pump 116 is propagated to the liquid developer G, and the amount of liquid developer G supplied to the supply roller 74 (a radius dimension on the circumferential surface of the supply roller 74) fluctuates in response to the pulsation.

The fluctuation in the supply amount of liquid developer G may affect the density of a developed image formed on the photoconductor drum 82, that is, the image density of the image may fluctuate.

Hereinafter, a causal relationship between the pulsation of the supply pump 116 and the fluctuation in image density will be discussed.

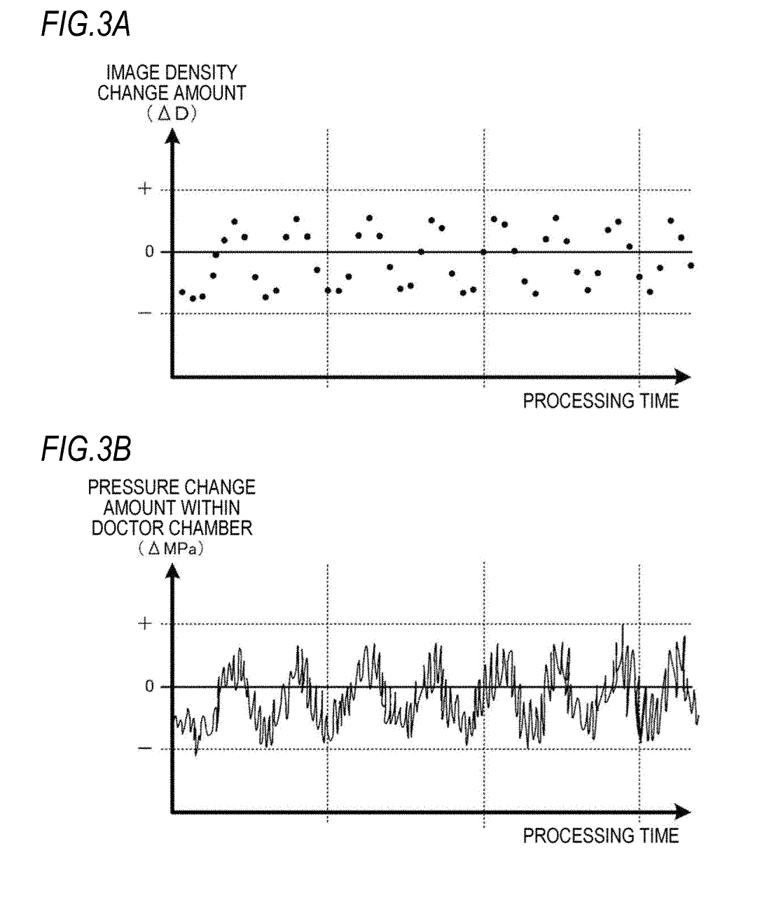

FIG. 3A is a characteristic diagram obtained by measuring an image density change amount ΔD with respect to a processing time when an image is formed based on image data having a certain image density (for example, a black solid image, a halftone gray image, or the like).

The image density is originally constant, and thus changes around zero level or within a predetermined allowable range. However, FIG. 3A illustrates that change in image density exceeds an allowable range. The absolute numerical value of the image density change amount ΔD changes depending on the image data, the type of the liquid developer G, and the like. Thus, although not described in FIG. 3A, it is found that even if at least conditions such as the image data and the type of the liquid developer G are changed, a periodic fluctuation occurs.

Meanwhile, FIG. 3B is a characteristic diagram obtained by measuring a pressure change amount ΔM Pa within the doctor chamber 118 when the supply pump 116 employed in the exemplary embodiment is driven to supply the liquid developer G to the doctor chamber 118.

In FIG. 3B, it is found that the pressure within the doctor chamber 118 varies at a cycle (frequency) caused by the pulsation of the supply pump 116.

That is, when the image density change amount in FIG. 3A is compared to the pressure change amount of liquid developer G in FIG. 3B, it is found that the changes occur at the same frequency, and the phases coincide with each other with respect to the horizontal axis, that is, the time (processing time) axis.

Although not illustrated in FIGS. 3A and 3B, it is obvious that when the amplitude of the pulsation of the supply pump 116 is small, the fluctuation of the image density is also reduced correspondingly. The reduction of the amplitude of the pulsation indicates that the flow rate of the liquid developer G becomes not small.

Therefore, in the exemplary embodiment, the pulsation of the supply pump 116 and the image data are analyzed in a correlated manner, and then a supply control of the liquid developer G, through which the pulsation of the supply pump 116 does not affect the image density, that is, the pulsation does not fluctuate the image density of an image, is achieved.

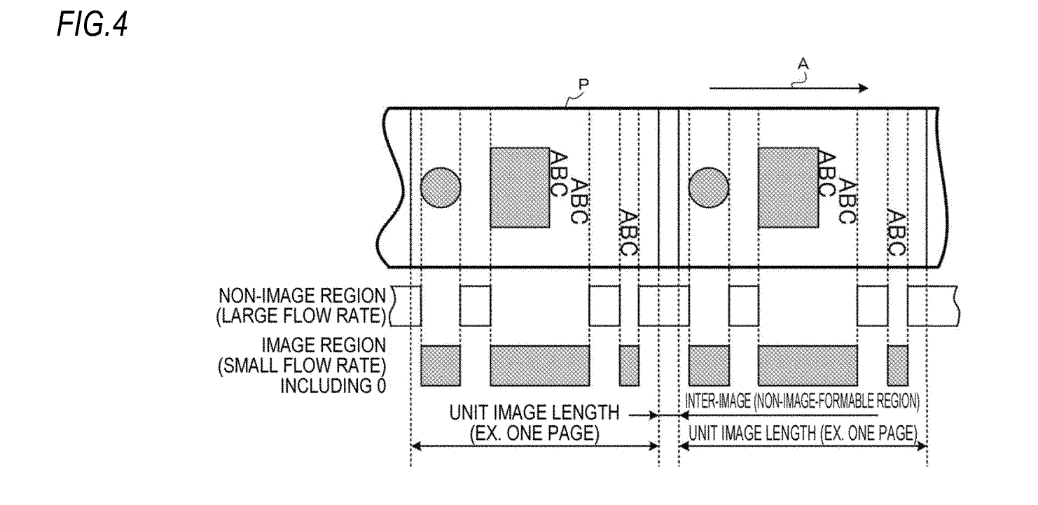

FIG. 4 is a plan view of the recording medium P on which images are formed and illustrates an example where the identical images are repeatedly formed over plural pages.

The direction of an arrow A in FIG. 4 is the transport direction (a process direction or a sub-scanning direction) of the recording medium P. Images are formed from the right side to the left side in FIG. 4. The width direction of the recording medium P (the direction intersecting the arrow A) is a main scanning direction in the photoconductor drum 82 when images are formed by the exposure device 84.

Here, when the entire area of the main scanning direction is viewed in the process direction, the recording medium P is classified into a region (an image region) on which an image is formed and a region (a non-image region) on which no image is formed. The non-image region includes a non-image-formable region (an inter-image region) between respective pages.

The non-image region on which images are not present at all in the main scanning direction is a region that does not affect the density change from the beginning. Therefore, in the exemplary embodiment, one page is set as a unit of a processing length and is classified into an image region and a non-image region. Then, the liquid developer G is supplied such that the amount (the reference flow rate) of liquid developer G required for one page is not constant, but the amount of liquid developer G in the image region and that in the non-image region are made different from each other.

More specifically, the liquid developer G is supplied, in a relatively large amount (a large flow rate), to the non-image region that does not affect (fluctuate) the image density, and the liquid developer G is supplied, in a relatively small amount (a small flow rate), to the image region that affects the image density. That is, the increase/decrease in the flow rate is canceled (±0) in a page unit. The flow rate of the liquid developer G is determined by a drive rotational speed of the supply pump 116. Thus, the rotational speed of the supply pump 116 in the image region and the rotational speed of the supply pump 116 in the non-image region are set so as to satisfy the following equation (1).

[(a1×x)+(a2×{1−x}]−(L×t×v)=z≥0 (1)

Definitions of respective variables are as follows.

(Definition 1) “a1” corresponds to the amount of liquid developer G supplied from the tank 110 to the doctor chamber 118 per unit time (a flow rate (g/min) (a large flow rate) in the non-image region).

(Definition 2) “a2” corresponds to the amount of liquid developer G supplied from the tank 110 to the doctor chamber 118 per unit time (a flow rate (g/min) (a small flow rate) in the image region).

In the image region, the small flow rate may be set to 0, which is optimum. In this case, a2=0.

(Definition 3) “x” is a ratio of the non-image region (the image length having no image data in the process direction) in the entire region in the width direction of the recording medium P (the main scanning direction) with respect to the entire image length (including an inter-image) in the process direction in one unit as the processing length, in which “1” corresponds to 100%.

(Definition 4) “L” is an image width of the recording medium P (a dimension “m” in the width direction).

(Definition 5) “t” is the amount (g/m²) of a developer supplied to the developing roller 85 per unit area.

(Definition 6) “v” is an image forming speed (m/min).

(Definition 7) “z” is the amount (g/min) of the liquid developer G that returns from the doctor chamber 118 to the tank 110 per unit time.

By calculating and setting a1 and a2 by the equation (1), it is possible to secure the necessary minimum amount of liquid developer G.

For example, when the flow rate a2 in the image region is set to 0 and calculation is made using x=0.3 (30%), L=0.37, t=10, and v=100, a result that a1 is 1233 g/min (≥0) is obtained. According to this result, the supply pump 116 is driven at a flow rate of 1233 g/min in the non-image region, and is stopped in the image region.

FIG. 2 is a functional block diagram according to the exemplary embodiment, in which the supply control of the liquid developer G by the supply pump 116 is executed in the main controller 100. Each block in FIG. 2 does not limit the hardware configuration of the main controller 100. For example, a part or all of functions may be processed by a program executed by a microcomputer.

As illustrated in FIG. 2, in the exemplary embodiment, in the image forming control section 104, when an image data receiver 122 receives image data, an exposure data generator 124 generates exposure data of each color, and an exposure control section 126 controls the exposure device 84 to perform exposure.

Here, a supply amount calculator 128 as an example of a correction unit acquires the exposure data from the exposure data generator 124, calculates a supply amount (supply amounts of liquid developer G in the image region and the non-image region) according to image formation processing based on the equation (1), and sends the supply amounts to a supply pump rotational speed converter 130.

The supply pump rotational speed converter 130 converts the supply amounts of liquid developer G into rotational speeds of the supply pump 116. A supply pump driving section 134 which is synchronized with the exposure control section 126 by a synchronization section 132 controls the driving of the supply pump 116. That is, the synchronization section 132 makes synchronization in consideration of a time lag between a timing at which the liquid developer G is supplied from the doctor chamber 118 to the supply roller 74 and a timing at which the supplied liquid developer G is developed on the photoconductor drum 82.

Hereinafter, the operation of the exemplary embodiment will be described.

(Flow of Image Formation)

First, the flow of processing for image formation in the image forming apparatus 10 will be described.

When receiving image data, the main controller 100 converts the image data into exposure data of the respective colors and sends the exposure data of the respective colors to the exposure devices 84 that constitute the image forming units 60.

Subsequently, based on an image formation execution instruction, in the image forming unit 60C, the photoconductor drum 82C is charged by the photoconductor charging device 83C, and the charged photoconductor drum 82C is exposed by the exposure device 84C, so that a latent image for the C color is formed on the photoconductor drum 82C. Then, the latent image for the C color is developed into a toner image of the C color by the developing roller 85C to which the liquid developer G for the C color is supplied from the developer supply section 70C.

Subsequently, the toner image of the C color reaches the nip N2 by the rotation of the photoconductor drum 82C, and is primarily transferred to the intermediate transfer roller 86C. Further, the toner image of the C color transferred to the intermediate transfer roller 86C reaches the nip N3 by the rotation of the intermediate transfer roller 86C. Then, the toner image of the C color that has reached the nip N3 is secondarily transferred to the surface of the recording medium P that is being transported, by the backup roller 88C.

Similarly, in the image forming units 60M, 60Y, and 60K that constitute the image forming units 60, toner images of the M, Y, and K colors are sequentially secondarily transferred to the surface of the recording medium P from the intermediate transfer rollers 86M, 86Y, and 86K to be superimposed on the toner image of the C color secondarily transferred to the surface of the recording medium P.

Subsequently, the recording medium P having a surface on which the toner images of the respective colors are formed by the image forming units 60 reaches the fixing device 90. Then, the toner images of the respective colors on the surface of the recording medium P are heated and pressed by the fixing device 90 and fixed to the surface of the recording medium P. Then, the recording medium P passes through the drying section 91, and is dried and wound on the winding roller 17 of the accommodating section 15.

As the recording medium P, non-conductive general paper Pn including paper and a resin film is representative.

(Drive Control of Supply Pump 116)

The pulsating pump is employed in the supply pump 116, and the liquid developer G is delivered in the closed state by the doctor chamber 118 from the tank 110 to the supply roller 74 without basically being exposed to air. This configuration may cause the following phenomenon. That is, the pulsation (vibration) of the supply pump 116 may affect (fluctuate) the density of a developed image formed on the photoconductor drum 82.

Therefore, in the exemplary embodiment, the liquid developer G is supplied, in a relatively large amount (at a large flow rate), to the non-image region that does not affect the image density, and the liquid developer G is supplied, in a relatively small amount (at a small flow rate), to the image region that affects the image density.

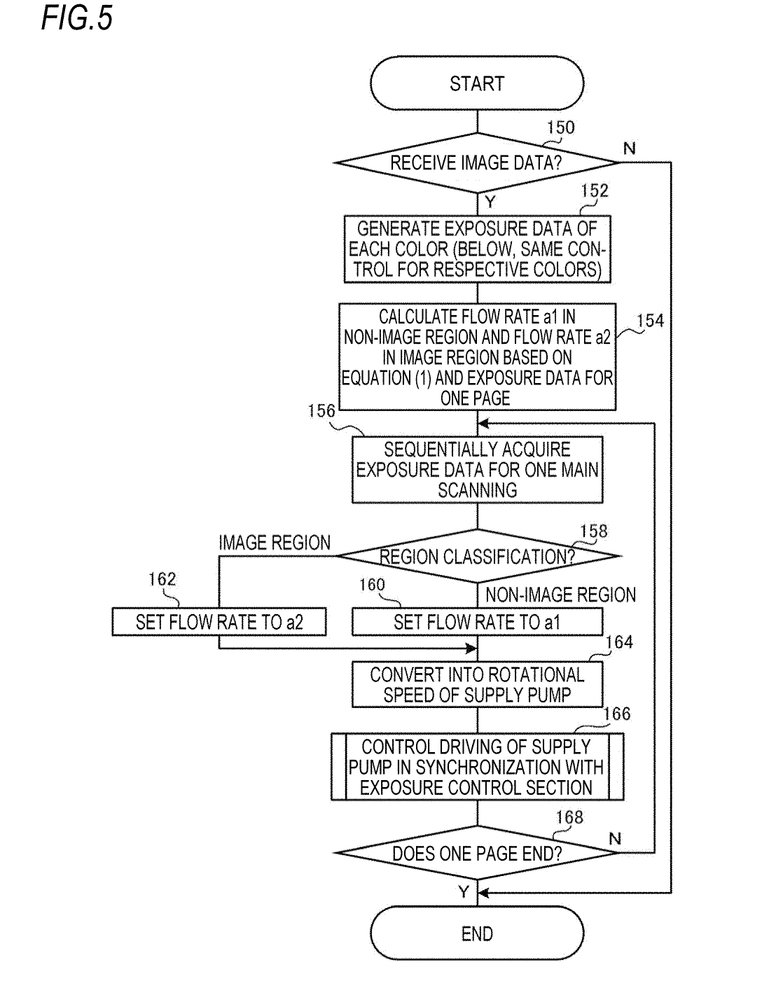

FIG. 5 is a flow chart according to the exemplary embodiment, illustrating the flow of a supply control of the liquid developer G by the supply pump 116 in the main controller 100.

In step 150, it is determined whether image data is received. If a negative determination is made, this routine ends.

If an affirmative determination is made in step 150, the process proceeds to step 152, and exposure data of the respective colors is generated. Then, the process proceeds to step 154. The following steps are executed as the same control, for each color.

In step 154, the flow rate al in the non-image region and the flow rate a2 in the image region are calculated based on the equation (1) and the exposure data for one unit (one page in the exemplary embodiment). It should be noted that it is optimal to set the flow rate a2 in the image region to 0. The condition is that a1≥0.

In the following step 156, exposure data for one main scanning is sequentially acquired, and the process proceeds to step 158. The acquisition may be made for one main scanning along the process direction, but may be made for plural lines (not limited to a predetermined number of lines).

In step 158, the acquired exposure data is classified into the non-image region or the image region.

If it is determined that the exposure data corresponds to the non-image region as a result of the classification in step 158, the process proceeds to step 160. The flow rate is set to a1, and the process proceeds to step 164.

If it is determined that the exposure data corresponds to the image region as a result of the classification in step 160, the process proceeds to step 162. The flow rate is set to a2, and the process proceeds to step 164.

In step 164, the set flow rate a1 or a2 is converted into a rotational speed of the supply pump 116, and the process proceeds to step 166.

In step 166, the exposure control section 126 controls the driving of the supply pump 116 in synchronization with the exposure processing using the exposure device 84, and the process proceeds to step 168. That is, the synchronization section 132 makes synchronization in consideration of a time lag between a timing at which the liquid developer G is supplied from the doctor chamber 118 to the supply roller 74 and a timing at which the supplied liquid developer G is developed on the photoconductor drum 82.

In step 168, it is determined whether the processing for one page is ended. If a negative determination is made, the process returns to step 156, and the above steps are repeated. If an affirmative determination is made in step 168, this routine ends.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a developing member to be supplied with a liquid developer from a supply member and configured to develop an electrostatic latent image formed on an image carrier;
a developer supply unit that forms a closed space together with the supply member, the closed space storing the liquid developer;
a pulsating pump configured to feed the liquid developer to the closed space at a predetermined reference flow rate; and
a correction unit configured to make a correction to achieve increase or decrease with respect to the reference flow rate according to presence or absence of image information used for forming the electrostatic latent image, in units of a predetermined processing length in a process direction intersecting a development width on the image carrier.

2. The image forming apparatus according to claim 1, wherein
for a unit of the processing length in which the image information used for forming the electrostatic latent image is present, the correction unit makes the correction to achieve the decrease with respect to the reference flow rate, and
for a unit of the processing length in which the image information used for forming the electrostatic latent image is absent, the correction unit makes the correction to achieve the increase with respect to the reference flow rate.

3. The image forming apparatus according to claim 2, the correction unit stops the pulsating pump in a range of the unit of the processing length in which the image information used for forming the electrostatic latent image is present.

4. The image forming apparatus according to claim 1, wherein the correction unit cancels an increase amount of a flow rate and a decrease amount of the flow rate, per the unit of the predetermined processing length.

5. The image forming apparatus according to claim 4, wherein the unit of the predetermined processing length corresponds to an image region for one page of a recording medium to which transfer is made from the image carrier.

6. The image forming apparatus according to claim 1, wherein the supply member includes a supply roller.

7. The image forming apparatus according to claim 1, wherein the developer supply unit includes a doctor chamber.

8. The image forming apparatus according to claim 1, wherein the image information includes exposure data.
